(19) United States
(12) Patent Application Publication
(10) Pub. No.: US 2004/0078207 A1
(43) Pub. Date: Apr. 22, 2004

(54) Method of reducing warranty costs for a calender

(76) Inventor: Timo Torvi, Helsinki (FI)

Correspondence Address: LATHROP & CLARK LLP, 740 REGENT STREET SUITE 400, P.O. BOX 1507, MADISON, WI, 537011507

(21) Appl. No.: 10/272,590

(22) Filed: Oct. 16, 2002

(51) Int. Cl. G06F 17/60

(52) U.S. Cl. 705/1

(57) ABSTRACT

A calender for paper or paperboard is sold together with a guarantee and preventative maintenance plan. The sales plan incorporates a warranty period of 3 to 5 years with a scheduled maintenance plan which is performed or overseen by the supplier of the calender. The scheduled maintenance is related to the warranty such that if the scheduled maintenance is not performed, the warranty is voided. The scheduled maintenance also allows the calender supplier to monitor the use of the calender and to inform the purchaser when it is evident that the calender is being misused. This method of sale of a calender and calender warranty minimizes unscheduled maintenance, and damage through improper operation.

### CROSS REFERENCES TO RELATED APPLICATIONS

Not applicable.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to calenders, calender maintenance, and structuring the sale of a calender to increase customer value.

In the economy of papermaking the most basic asset is standing timber which can be harvested and made into paper. The process of turning standing timber into paper has many steps including harvesting the timber, reducing the logs harvested to wood chips, processing the wood chips to produce wood fiber, and forming a paper sheet from the wood fibers, and finally finishing the paper by coating and calendering the finished web. The value of the product formed increases as it is further processed. As greater value is added to the natural resource of the standing timber, greater investments in capital equipment and labor are required.

The natural path of development for the economy which has significant timber resources is to begin by exporting timber and, through investment over time, to progress to the export of paper. At the same time developing countries are desirous of maximizing the value of their exports by selling their pulp resources as finished paper, paperboard or linerboard, the technology of manufacture, at least in certain aspects, has become very sophisticated. In particular in producing better grades of paper to maximizes the value of what is produced. One component which can be particularly economically advantageous in improving the quality of paper or paper board produced is the calender.

Calendering is particularly advantageous because it results in a more valuable product with very little additional input of resources. Thus in recent times intense technological development has occurred with respect to calendering whether that be on-machine, or off-machine calendering. This growing sophistication in the technology of calendering produces a problem associated with selling and using calenders in countries which do not have the most sophisticated indigenous technological base. Because the calender provides the potential of such high returns on investment, the calender may be the most sophisticated part of the papermaking process.

In a country or region where the level of indigenous technology and investment is sufficient to support papermaking, it may still be true that the ability to maintain and thus maximize the value produced by a technologically advanced calender is compromised. For the seller of sophisticated calenders, problems arising during the guarantee time period, due to faulty operation or maintenance, represent an additional cost of sale. For the purchaser, difficulties with reliability produced by operational errors, or lack of proper maintenance, impede fully recovering the expected returns on the investment represented by the calender. What is needed is a sales package which increases the value of a technologically sophisticated calender to the purchaser who does not have access to an indigenous maintenance staff of sufficient technological sophistication to assure optimal functionality of the calender, while increasing the profitability to the calender supplier by preventing unusually high warranty costs and customer dissatisfaction.

### SUMMARY OF THE INVENTION

The method of selling a paper calender of this invention involves selling a calender together with a guarantee and a preventative maintenance plan. Calenders are typically sold with a guarantee or warranty of one to two years. However, depending upon the availability of sophisticated maintenance personnel, a calender may have high warranty costs. The sales plan of this invention incorporates a longer warranty or guarantee period, for example three to five years, with a scheduled maintenance plan which is performed or overseen by the supplier of the calender. The scheduled maintenance plan is either included in the price of the calender, is performed at an agreed-upon cost, or is performed according to the customary charging practices of the industry.

The scheduled maintenance is connected to the warranty such that if the scheduled maintenance is not performed, the warranty is voided. The scheduled maintenance also allows the calender supplier to monitor the use of the calender and to inform the purchaser when it is evident that the calender is being misused. This monitoring and communication prevents or reduces damage to the calender and allows costs associated with abusive use to be charged to the customer. This method of sale for a calender and calender warranty minimizes unscheduled maintenance allowing for a more cost-effective scheduling of the supplier's maintenance personnel. The result is better cost recovery and reduced warranty service costs for the seller. For the purchaser, a longer period of guaranteed reliability and effectiveness maximizes return on investment and reduces risk because expected economic benefits of employing the calender are realized with greater assurance over a longer period of time.

It is an object of the present invention to provide a calender sales package which reduces the cost of warranty repairs.

It is another object of the present invention to provide a method of selling a calender wherein the purchaser has greater assurance of realizing the expected economic benefits associated with purchase of the calender.

It is a further object of the present invention to provide a method of selling a calender which provides for better maintenance and better allocation of maintenance costs.

Further objects, features and advantages of the invention will be apparent from the following detailed description when taken in conjunction with the accompanying drawings.

### BRIEF DESCRIPTION OF THE DRAWINGS

Not applicable.

### DESCRIPTION OF THE PREFERRED EMBODIMENTS

A calender, whether of the on-machine type, or the type used to process paper or paperboard after it has been wound into a reel, can be an item of papermaking equipment with a high rate of return. This is because the calender has the effect of improving the quality and thus the value of the paper web with relatively little additional manufacturing costs. The costs associated with the calender are the capital cost, maintenance costs, and energy cost, but only minor material costs. This is in contrast to the basic process of making paper, where improved paper quality often involves use of more expensive fiber, additives, or coatings which can add substantially to the cost of manufacture. Further, because the calender operates on relatively dry paper, even where the paper is remoisturized and heated, the energy cost is relatively low compared to the cost of manufacturing the paper web. The relatively low operating cost combined with a substantial improvement in paper properties which increase the value of the paper treated by the calender, allows calenders to be very capital-intense devices.

Capital is the dominant cost associated with the calender, hence it is capital cost which is principally increased until no further benefit is achieved from greater capital expenditure. Because of the high productivity of all papermaking machinery, particularly calenders, a small increase in the ability of the calender to improve the value of the paper web being calendered will support a substantial capital investment. Thus calenders tend to be highly sophisticated devices which employ the latest technology developments, because of the high economic return of which the calender is capable.

Calenders are not only capable of providing a high return on investment, but, because they can increase the value of the web without substantial change to the rest of the papermaking process or boardmaking process, it is often economical to add a sophisticated calender to an existing papermaking plant, even if the plant is of relatively low technical sophistication. This ability of the calender to add value to the output of any papermaking machine means that the calender is often the most sophisticated part of a papermaking operation. However, where there is a disparity between the technology employed in the calender and that employed in the remainder of the papermaking process, adequate maintenance and proper use of the calender may pose problems. A lack of personnel familiar with the technology employed by the calender and its need for careful monitoring, adjustment, and maintenance in order to achieve its designed function, may result in unexpectedly high warranty costs to the manufacturer and unexpectedly low availability to the purchaser.

The method of this invention provides a solution to this problem by packaging the sale of a technologically sophisticated calender with a warranty and a scheduled maintenance plan which covers the period of the warranty. Both the warranty and the scheduled maintenance plan may be for an extended period of time, for example, three to five years. Both the calender and the associated scheduled maintenance plan are sold at a selected price, which may be fixed at the time of sale, or which may be dependent upon future variables, such as total machine running time or length of web produced. Although the selected price includes charges associated with the performance of the preventative maintenance, the purchaser may not be required to pay those portions of the selected price associated with the performance of preventative maintenance until such time as the preventative maintenance is actually performed.

The scheduled maintenance plan sets forth the tasks which must be performed under the sales agreement to keep the warranty in force. The scheduled maintenance tasks may be scheduled on the basis of calendar time or on the number of operation hours, or even the length of web calendered. The maintenance tasks may include inspections, lubrication, replacement of wear items, testing of actuators and control software, alignment of components, measurement of performance or static parameters, cleaning, refurbishing, running diagnostic software, performing diagnostic material tests on the calender or on paper which is passed through the calender, and such other tests and processes which have been determined in the past or may be developed in the future to facilitate the functioning of the calender or the prolonging of the calender's life.

The tasks carried out according to the sales agreement with respect to the preventative maintenance schedule will typically be performed in accordance with a maintenance manual, either electronic or in printed form. The maintenance is performed according to the maintenance plan under the control of the entity selling the calender, i.e., the work will be performed by the staff or employees of the calender seller or at least the staff or employees of the calender seller will supervise or direct the performance of the tasks set forth in the preventative maintenance schedule.

An important aspect of the maintenance plan is the reporting of the result to the seller of the calender of any tests or data gathered while performing the maintenance tasks, or reviewed, summarized, or downloaded in accordance with the maintenance plan. The scheduled maintenance plan tasks are carried out directly by the calender seller or under the supervision of the calender seller. In this way the seller, who has the contractual obligation with respect to the warranty, is in a position to see that the calender is being properly maintained, and to discover if the calender is being used in such a way as to be inconsistent with the design specification, or so as to result in damage to the calender or unsatisfactory operation of the calender. The contractual obligations of the seller under the warranty are dependent upon the scheduled maintenance being performed according to the scheduled maintenance plan under control of the entity selling the calender. Which is to say, if the customer does not allow or pay for the scheduled maintenance, then the seller is no longer obliged under the warranty to make additional repairs.

It is understood that the term “warranty” incorporates the concept of guarantee, and is a contractual obligation, which obliges the seller of the calender in some way, typically by requiring the seller of the calender to make repairs or improvements, or payments to the seller if the calender fails to operate or perform as set forth in the sales agreement for the period of time to which the agreement relates.

The length of the scheduled maintenance plan is preferably commensurate with the length of the calender warranty, i.e., the warranty remains in effect for the period that the scheduled maintenance is performed. Although it should be understood that the warranty may extend beyond the last scheduled maintenance for a period of time which a continuation of the maintenance plan would not dictate a scheduled maintenance. In other words, if the scheduled maintenance plan requires the bearing alignment be checked and verified each month, the warranty may extend for up to one month after the last bearing alignment check. However, during the warranty period, failure to perform a scheduled maintenance task at a required time results in the voiding of the warranty. It is understood that the warranty agreement provides an interval range, during which the required maintenance must be performed, so that ordinary contingencies associated with scheduling machine downtime are allowed for.

It is understood that the invention is not limited to the particular construction and arrangement of parts herein illustrated and described, but embraces all such modified forms thereof as come within the scope of the following claims.

I claim:

1. A method of selling a papermaking or boardmaking calender comprising the steps of:
selling a calender and a calender warranty of three or more years, at a selected price;
performing scheduled preventative maintenance on the calender sold, according to a scheduled maintenance plan commensurate with the length of the calender warranty, the maintenance being performed according to the maintenance plan, and under the control of the entity selling the calender;
wherein rights under the warranty are dependent upon the the scheduled maintenance being performed according to the scheduled maintenance plan, and under the control of the entity selling the calender.

2. The method of claim 1 wherein the scheduled preventative maintenance is scheduled to occur after the machine has operated for a selected number of hours.

3. The method of claim 1 wherein the scheduled preventative maintenance is scheduled to occur after a selected passage of time.

4. Wherein the selected price includes charges associated with the performance of the preventative maintenance, but wherein a purchaser is not required to pay those portions of the selected price associated with the performance of preventative maintenance until such time as the preventative maintenance is actually performed.
